(19) United States
(12) Patent Application Publication
(10) Pub. No.: US 2013/0087986 A1
(43) Pub. Date: Apr. 11, 2013

(54) PADDED BOW STOP

(71) Applicant: Ron Stansfield, West Jordan, UT (US)

(72) Inventor: Ron Stansfield, West Jordan, UT (US)

(21) Appl. No.: 13/269,388

(22) Filed: Oct. 7, 2011

(51) Int. Cl. B60P 3/10

(52) U.S. Cl. 280/162; 280/161

(57) ABSTRACT

A resilient cushioned bow stop for use on boat trailers to protect the bow of boats when launching, retrieving, and transporting boats in and out of the water includes a cushioned non-abrasive protective covering, molded and bonded to independently rotating rollers.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates generally to an apparatus for securing boats to trailers for the purpose of transporting the boats. More particularly, the present invention relates a bow stop device configured for being located on a boat trailer used to launch, retrieve, and transport boats in and out of the water and configured for securing the bow of a boat to the trailer and providing padding between the securing device and the bow of the boat.

### BRIEF SUMMARY OF THE INVENTION

It is a feature of an illustrative embodiment of the present invention to provide an apparatus for securing a boat to a trailer by providing a bow-securing device located at the bow end of a boat trailer and sized and shaped to secure the bow of the boat when the boat is loaded onto the trailer. It is also a purpose of an illustrative embodiment of the present invention to provide padding between the bow-securing device and the bow of the boat to prevent damage to or scuffing of the bow by the bow-securing device. Most commercially available boat trailers come equipped with polyurethane or rubber bow stop rollers, which can leave marks, scratches, and residues and over time wear completely through the fiberglass gel coat or other coating of a boat. The grade on various boat launch ramps can cause the bow stop to come in contact with and damage other areas on the bow of the boat not meant for contact.

An illustrative embodiment of this invention is directed to protecting the finished fiberglass or other surfaces located on the bows of boats, which come into contact with the bow stop during launching, retrieving, and transporting of boats in and out of the water. An illustrative embodiment of this invention is also directed to protecting all finished surfaces of boats not meant for bow stop contact. This invention is also directed to protecting all finished surfaces of boats that come into contact with the bow stop during launching, retrieving, and transporting boats to and from destinations, and into and out of water.

An illustrative bow stop device according to the present invention comprises;

a center member configured to receive the bow of a boat, and having two opposing, generally flat first meeting surfaces,

two end members, each end member comprising a generally flat second meeting surface, wherein the end members are disposed on the center member by juxtaposing the first and second meeting surfaces,

wherein the center member and the two end members each comprise a covering layer.

In another illustrative embodiment, the center member and the two end members have a common axis. The center member and the two end members can rotate independently of each other about the common axis. The center member and the two end members may each comprise a hole disposed along the common axis, the hole configured for receiving a rod. A rod, such as a bolt, may be disposed in the holes of the center member and the two end members.

The center member comprises a middle section and two end sections, each of the middle section and the end sections having at least one cross-sectional diameter, wherein the at least one cross-sectional diameter of the middle section is smaller than the at least one cross-sectional diameters of the end sections.

The two end members comprise at least one cross-sectional diameter, and the at least one cross-sectional diameters of the two end members are larger than the at least one cross sectional diameters of the end sections of the center member.

The two end members may each comprise a distal recess configured for receiving a concave washer, and a concave washer may be disposed in each distal recess. A washer, such as a flat washer, may also be disposed between the center member and each end member.

The covering layer may comprise a woven material.

Another illustrative embodiment of the invention comprises a bow stop device configured to receive the bow of a boat comprising:

a center member comprising a middle section and two end sections, each of the middle section and the two end sections having at least one cross-sectional diameter, wherein the at least one cross-sectional diameter of the middle section is smaller than the at least one cross-sectional diameters of the end sections, the center member also comprising two opposing, generally flat first meeting surfaces;

two end members each comprising a generally flat second meeting surface, wherein the end members are disposed on the center member by juxtaposing the first and second meeting surfaces, each of the two end members comprising at least one cross-sectional diameter, wherein the at least one cross-sectional diameter of the end members is larger than the at least one cross sectional diameters of the end sections of the center member, the two end members each also comprising a distal recess configured for receiving a concave washer;

a washer disposed between the center member and each end member;

a concave washer disposed in each distal recess of the end members;

wherein the center member and the two end members each comprise a covering layer comprising a woven material;

wherein the center member and the two end members have a common axis, wherein the center member and the two end members each comprises a hole disposed along the common axis, the hole configured for receiving a rod and wherein the center member and the two end members can rotate independently of each other about the common axis; and

a rod disposed through the holes in the center member and the two end members.

Still another illustrative embodiment of the invention comprises an apparatus comprising:

a frame comprising two parallel walls; and

a plurality of bow stop devices disposed between the parallel walls, wherein each of the bow stop devices is configured to receive the bow of a boat;

wherein each of said bow stop devices comprises a covering layer.

### BRIEF DESCRIPTION OF THE SEVERAL VIEWS OF THE DRAWINGS

FIG. 1 is a side view of an illustrative embodiment of the padded bow stop device depicting its location in relationship to the trailer and boat.

FIG. 2 is a front view of a bow stop device.

FIG. 3 is a cutaway front view of the bow stop device.

FIG. 4 is an exploded perspective view of the bow stop device.

FIG. 5 is a side view of the bow stop device.

FIG. 6 is a perspective view of an illustrative embodiment of a device comprising a plurality of bow stop devices.

### DETAILED DESCRIPTION

Before the present bow stop device is disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

It must be noted that, as used in this specification and the appended claims, the singular forms “a,” “an,” and “the” include plural referents unless the context clearly dictates otherwise.

Unless defined otherwise, all technical and scientific terms used herein have the same meanings as commonly understood by one of ordinary skill in the art to which this invention belongs.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “consisting of” and grammatical equivalents thereof exclude any element, step, or ingredient not specified in the claim.

As used herein, “consisting essentially of” and grammatical equivalents thereof limit the scope of a claim to the specified materials or steps and those that do not materially affect the basic and novel characteristic or characteristics of the claimed invention.

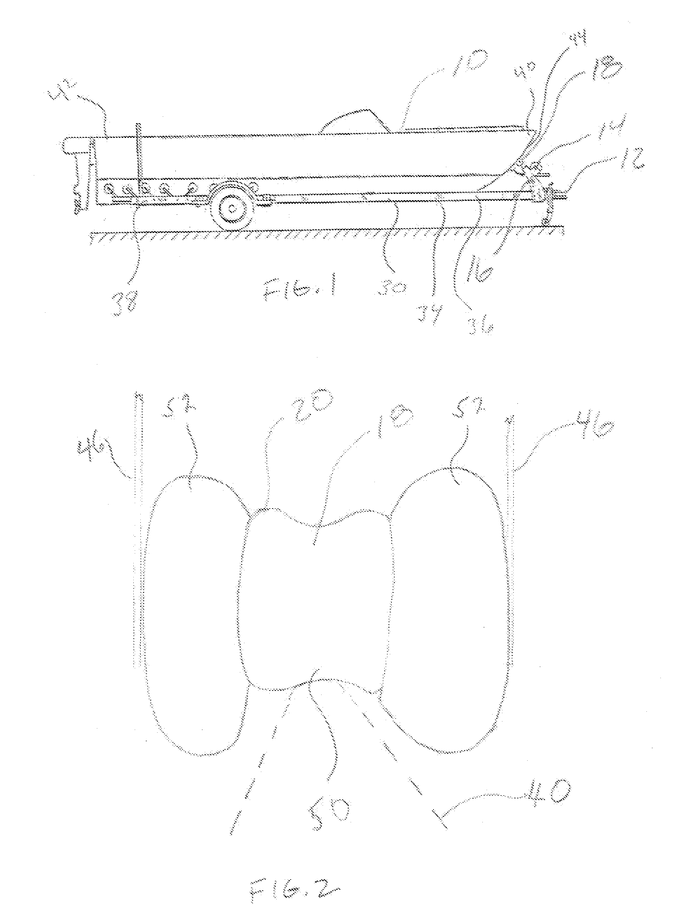

An illustrative embodiment of the present invention is illustrated in FIGS. 1-4. FIG. 1 is a side view depicting the trailer 30 generally comprising a frame 34 having a bow end 36 and a stern end 38, said bow end 36 and stern end 38 correlating to the bow 40 and stern 42 of a boat 10. In this illustration, the boat 10 is depicted mounted on the trailer 30. The trailer 30 further comprises a tongue 12 located at the bow end 36 and extending forward therefrom. The trailer 30 further comprises an upright 16 located at the bow end 36 of the frame 34. A winch 14 is located on the upright 16. A bow stop device 18 is also located on the bow end 36 of the frame. Generally, the bow stop device 18 should be positioned such that when the boat 10 is loaded onto the trailer 30, the bow stop device 18 receives the bow 40 of the boat 10.

In FIG. 1, the boat 10 is depicted in a loaded and secured position on the trailer 30. In the loaded position, the bow 40 of the boat 10 is in contact with the bow stop device 18. Among other things, the bow stop device 18 is positioned to prevent forward movement of the boat with respect to the trailer 30.

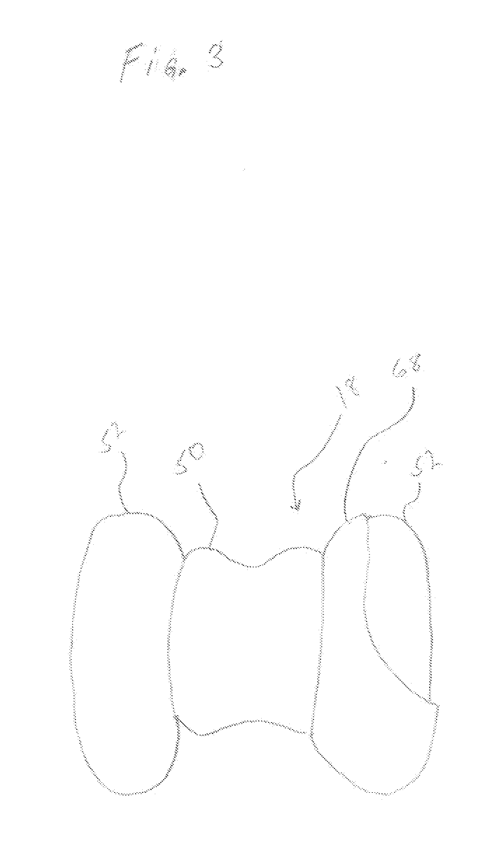

FIG. 2 shows a front elevation view of the bow stop device 18. The bow stop device 18 comprises a center piece 50 and two end pieces 52. The center piece 50 is separate from the end pieces 52 such that the center piece 50 and the two end pieces 52 can rotate independently of each other. The center piece 50 is shaped to receive the bow 40 of a boat (shown in phantom). The end pieces 52 possess a generally larger cross-sectional diameter than does the center piece 50. This design configuration imparts to the bow stop device a generally hourglass shape with the center piece 50 forming the waist. This hourglass shape acts to channel the bow of the boat into the center piece 50 as the boat is being loaded onto the trailer. The bow stop device 18 may be affixed to the trailer via arms 46 or other means known in the art. The arms are 46 affixed to the trailer and possess sufficient distance between them to allow the bow stop device 18 to fit between them.

FIG. 3 depicts a cutaway view of the bow stop device 18. The center piece 50 and end pieces 52 that give the bow stop device 18 its shape are depicted. The center piece 50 and end pieces 52 possess a covering 68. The covering 68 provides cushioning and protection scuffing or otherwise marring the surface of the boat. The covering 68 may be made of any rubberized or fabric material so long as it provides cushioning and scuff-protection functionality. The covering 68 may be provided with pressure sensitive adhesive on the interior surface, and/or hook and loop fasteners, and/or elastic cords, and/or other means known in the art for attaching the cover to the bow stop device 18. Accordingly, the cover may be configured to fit over the bow stop device 18 and to be fastened in place to thereby provide a replaceable protective device for protecting the bow of a boat against scratches or markings caused by the bow stop device 18.

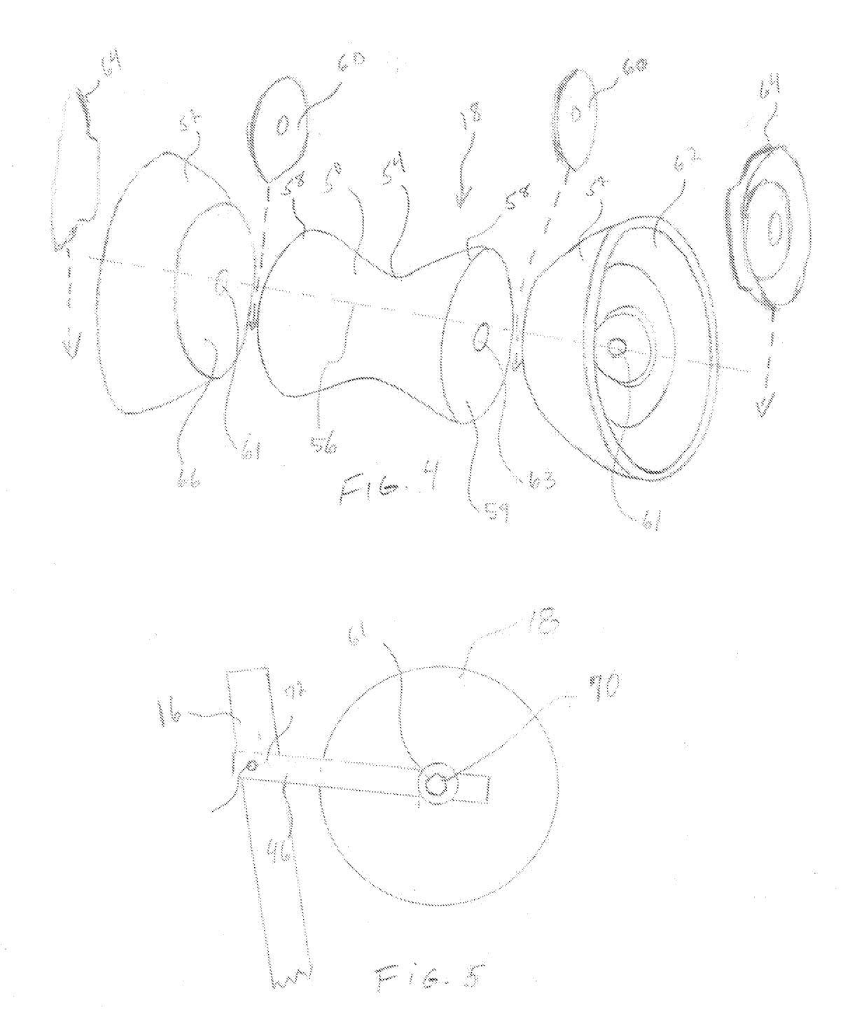

FIG. 4 depicts an exploded view of the bow stop device 18. The center piece 50 is shaped such that its cross-sectional diameter is smaller at its mid point 54 than at either end 58 such that the cross-sectional diameter possesses a gradually narrowing taper near the midpoint of the center piece 50. Each end 58 of the center piece 50 comprises a generally flat meeting surface 59. Each piece of the bow stop device 18 possesses an opening 61, 63 extending through the piece at its center. When the bow stop device is assembled, the center piece 50 and the end pieces 52 have a common axis 56. The openings 61, 63 are on the common axis 56. The center piece 50 and the end pieces 52 can rotate independently of each other about the common axis 56. Each end piece 52 possesses a recess 62 on its distal end and a generally flat meeting surface 66 on its proximal end. A rod, such as a bolt (not shown), can be inserted through the openings 61, 63 as a means of connecting the pieces of the bow stop device 18 together. Washers 60 may be inserted between all the meeting surfaces 59, 66 of the center piece 50 and the end pieces 52. A custom washer 64, sized and shaped to fit into the recess 62, may be located on the distal end of each end piece 52.

The shaped pieces of the bow stop device 18 may be made of molded material such as polyurethane or other plastic. In addition, the bow stop device shaped pieces may be made or cut from stock material by turning on a lathe or other shaping means. The bow stop device may be made of hard material or a soft and flexible material. The fact that the end pieces are separate from the center piece allows the end pieces to rotate separately from the center piece to reduce scuffing and wear on the bow of the boat as it is being loaded and transported.

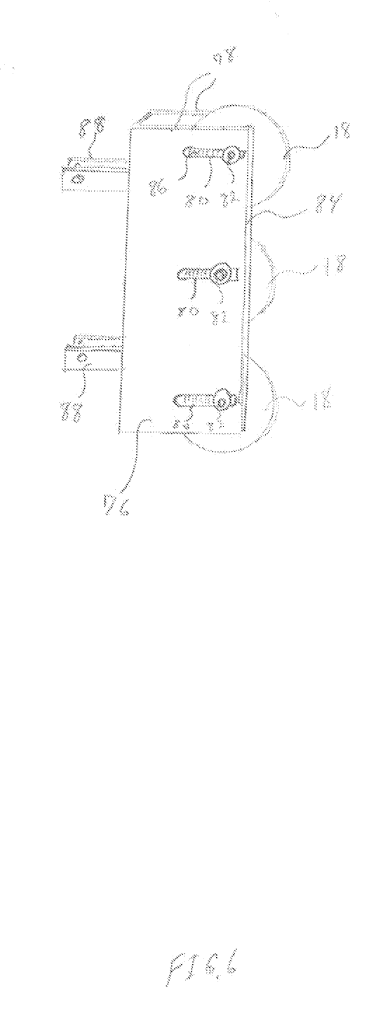

FIG. 5 depicts a side view of the bow stop device 18. A bolt 70 passes through the opening 61 of each piece such that, when a nut (not shown) is affixed to the threaded end of the bolt 70, the three pieces of the bow stop device 18 are held together and permitted to rotate with respect to each other. The bolt 70 also passes through an opening in the arms 46 for attaching the bow stop device 18 to the trailer. The distal end 72 of the arms 46 may be attached to the trailer upright 16 via a bolt 74. In the alternative, the bow stop device 18 may be attached to the trailer upright 16 in any manner known to those skilled in the art.

FIG. 6 depicts an illustrative embodiment of a device comprising a plurality of bow stop devices 18. Each of said bow stop devices 18 is biasedly affixed to a frame member 76. As depicted in FIG. 6, the frame member 76 possesses two generally parallel surfaces 78. Each of the two generally parallel surfaces 78 contains a plurality of slotted openings 80 through each of which can be fitted a bolt 82. Each bolt secures one of the bow stop devices 18. The bolt 82 holds the bow stop device 18 in place positioned between the two generally parallel surfaces 78 of the frame member 76, such that a portion of the bow stop device 18 surface extends beyond the leading edge 84 of the frame member 76. The bolts 82 can travel within the slotted openings 80. A biasing device 86 is in contact with each bolt 82 and the frame member 76 such that each bolt 82 can travel within the slotted openings in a biased manner. In an illustrative embodiment, the biasing device 86 comprises a spring. However, the biasing device can comprise any other biasing means known in the art. The frame member 76 is capable of being affixed to the bow end of the boat trailer via a plurality of arms 88 and aligned such that each bow stop device 18 moves independently of the other bow stop devices 18 in a more or less horizontal direction as each is contacted by the bow of the boat (not shown) so as to cause the plurality of bow stop devices 18 to conform to the shape of the bow of the boat and allow each bow stop device 18 to remain in contact with the bow of the boat when the boat is loaded on the trailer.

The subject matter claimed is:

1. A bow stop device comprising:
a center member configured to receive the bow of a boat, and having two opposing, generally flat first meeting surfaces,
two end members, each end member comprising a generally flat second meeting surface, wherein the end members are disposed on the center member by juxtaposing the first and second meeting surfaces,
wherein the center member and the two end members each comprise a covering layer.

2. The bow stop device of claim 1 wherein the center member and the two end members have a common axis.

3. The bow stop device of claim 2 wherein the center member and the two end members can rotate independently of each other about the common axis.

4. The bow stop device of claim 2 wherein the center member and the two end members each comprise a hole disposed along the common axis, the hole configured for receiving a rod.

5. The bow stop device of claim 4 further comprising a rod disposed in the holes of the center member and the two end members.

6. The bow stop device of claim 1 wherein the center member comprises a middle section and two end sections, each of the middle section and the end sections having at least one cross-sectional diameter, wherein the at least one cross-sectional diameter of the middle section is smaller than the at least one cross-sectional diameters of the end sections.

7. The bow stop device of claim 6 wherein the two end members comprise at least one cross-sectional diameter, and the at least one cross-sectional diameters of the two end members are larger than the at least one cross sectional diameters of the end sections of the center member.

8. The bow stop device of claim 1 wherein the two end members each comprise a distal recess configured for receiving a concave washer.

9. The bow stop device of claim 8 further comprising a concave washer disposed in each distal recess.

10. The bow stop device of claim 1 wherein the covering layer comprises a woven material.

11. The bow stop device of claim 1 further comprising a washer disposed between the center member and each end member.

12. A bow stop device configured to receive the bow of a boat comprising:
a center member comprising a middle section and two end sections, each of the middle section and the two end sections having at least one cross-sectional diameter, wherein the at least one cross-sectional diameter of the middle section is smaller than the at least one cross-sectional diameters of the end sections, the center member also comprising two opposing, generally flat first meeting surfaces;
two end members each comprising a generally flat second meeting surface, wherein the end members are disposed on the center member by juxtaposing the first and second meeting surfaces, each of the two end members comprising at least one cross-sectional diameter, wherein the at least one cross-sectional diameter of the end members is larger than the at least one cross sectional diameters of the end sections of the center member, the two end members each also comprising a distal recess configured for receiving a concave washer;
a washer disposed between the center member and each end member;
a concave washer disposed in each distal recess of the end members;
wherein the center member and the two end members each comprise a covering layer comprising a woven material;
wherein the center member and the two end members have a common axis, wherein the center member and the two end members each comprises a hole disposed along the common axis, the hole configured for receiving a rod and wherein the center member and the two end members can rotate independently of each other about the common axis; and
a rod disposed through the holes in the center member and the two end members.

13. An apparatus comprising:
a frame comprising two parallel walls; and
a plurality of bow stop devices disposed between the parallel walls, wherein each of the bow stop devices is configured to receive the bow of a boat;
wherein each of said bow stop devices comprises a covering layer.
